(19) United States
(12) Patent Application Publication
(10) Pub. No.: US 2019/0017564 A1
(43) Pub. Date: Jan. 17, 2019

(54) OVERTURN PREVENTING DEVICE AND METHOD OF MOUNTING THE SAME

(71) Applicant: KYB CORPORATION, Minato-ku, Tokyo (JP)

(72) Inventors: Shinichi SEKINE, Minato-ku, Tokyo (JP); Akihisa OOTA, Minato-ku, Tokyo (JP); Masaya UNE, Minato-ku, Tokyo (JP); Atsushi TOYOUCHI, Minato-ku, Tokyo (JP); Yukiko ISHIHARA, Minato-ku, Tokyo (JP); Chika IIDA, Minato-ku, Tokyo (JP)

(73) Assignee: KYB CORPORATION, Minato-ku, Tokyo (JP)

(21) Appl. No.: 16/069,306

(22) PCT Filed: Feb. 20, 2017
(86) PCT No.: PCT/JP2017/006209

§ 371 Date: Jul. 11, 2018

(30) Foreign Application Priority Data
Mar. 15, 2016 (JP) 2016-050410

(51) Int. Cl. F16F 9/06; A47B 97/00; F16F 15/02

(52) U.S. Cl. CPC F16F 9/06; A47B 2097/008; F16F 15/02; A47B 97/00

(57) ABSTRACT

Providing an overturn preventing device which can easily be mounted between a top surface of an article and a ceiling and a method of mounting the overturn preventing device. The overturn preventing device includes a damper. The damper is mounted between a top surface of a piece of furniture (an article) and a ceiling. The damper includes a cylinder and a piston. A hydraulic fluid (operating liquid) and a compressed gas are enclosed in the cylinder. The piston is slidably housed in the cylinder. When the damper is to be mounted between the top surface of the furniture and the ceiling, the piston is housed in the compressed gas enclosed above the hydraulic fluid. The piston can be moved into the hydraulic fluid when the furniture is tilted and the damper is contracted by a predetermined length.

### TECHNICAL FIELD

The present invention relates to an overturn preventing device and a method of mounting the same.

### BACKGROUND ART

Patent Document 1 discloses a conventional overturn preventing device. The overturn preventing device includes a damper. The damper is mounted between a top surface of a piece of furniture installed on a floor surface and a ceiling. The damper has two ends to which paired bases are respectively coupled. The bases respectively support the ends of the damper so that the ends are rotatable about rotation axes. One of the bases abuts against the top surface of the furniture and the other end abuts against the ceiling. As a result, in this overturn preventing device, when the furniture is tilted by shaking of earthquake or the like in a direction parallel to a rotation direction of the damper, the damper is rotated about the rotation axes relative to the bases so that the bases can be maintained in abutment against the top surface of the furniture and the ceiling respectively. As a result, this overturn preventing device can apply a damping force of the damper to the furniture thereby to suppress the tilt of the furniture and prevent the furniture from overturn.

### PRIOR ART DOCUMENT

### Patent Documents

Patent Document 1: Japanese Patent Application Publication No. JP 2015-6330

### SUMMARY OF THE INVENTION

### Problem to Be Overcome by the Invention

However, when the overturn preventing device of Patent Document 1 is to be mounted between the top surface of the furniture and the ceiling, the overturn preventing device needs to be mounted so as to assume a desired mounting posture while the damper is being contracted against an expansion force of compressed gas acting in an extension direction of the damper. Furthermore, when the damper is contracted, drag (or fluid resistance) of a hydraulic fluid (operating liquid) is generated which serves as a damping force of the damper. It is hard for a worker to carry out a mounting work against the aforementioned forces while contracting the damper above the furniture.

The present invention was made in view of the above-described circumstances in the conventional art and has an object to provide an overturn preventing device which can easily be mounted between the top surface of the furniture and the ceiling and a method of mounting the overturn preventing device.

### Means for Overcoming the Problem

An overturn preventing device in accordance with the invention includes a damper. The damper is to be mounted between a top surface of an article installed on an installation surface and a ceiling. The damper includes a cylinder and a piston. The cylinder encloses an operating liquid and a compressed gas. The piston is housed in the cylinder so as to be slidable. When the damper is to be mounted between the top surface of the article and the ceiling, the piston is housed in the compressed gas enclosed above the operating liquid in the cylinder.

In the overturn preventing device in accordance with the invention, the piston may be moved into the operating liquid when the article is tilted with a result that the damper is contracted by a predetermined length.

The abovementioned “predetermined length” should not be limited. Setting the predetermined length to a smaller value is preferred since the piston is moved into the operating liquid by a smaller amount of contraction of the damper.

A method of mounting the overturn preventing device, in accordance with the invention includes a step of mounting the damper between the top surface of the article and the ceiling. When mounting the damper, the damper is in a contracted state and the piston is housed in the compressed gas enclosed above the operating liquid in the cylinder.

### BRIEF DESCRIPTION OF THE DRAWINGS

FIG. 1 is a schematic diagram of the overturn preventing device of an embodiment;

FIG. 2 is a side view of the overturn preventing device of the embodiment, mounted between the top surface of the furniture and the ceiling;

FIG. 3 is a partially sectional view of the damper and a first base of the overturn preventing device of the embodiment;

FIG. 4 is a schematic sectional view of a major part of the overturn preventing device of the embodiment in the mounted state;

FIG. 5 is a side view of the overturn preventing device, illustrating the condition in which the damper is contracted with the result the piston is moved into a region of the hydraulic fluid; and

FIG. 6 is a schematic sectional view of the major part of the overturn preventing device of the embodiment under the condition in which the damper is contracted and the piston is moved into the region of the hydraulic fluid.

### BEST MODE FOR CARRYING OUT THE INVENTION

An embodiment of the overturn preventing device in accordance with the present invention and a method of mounting the same will be described with reference to the drawings.

### Embodiment

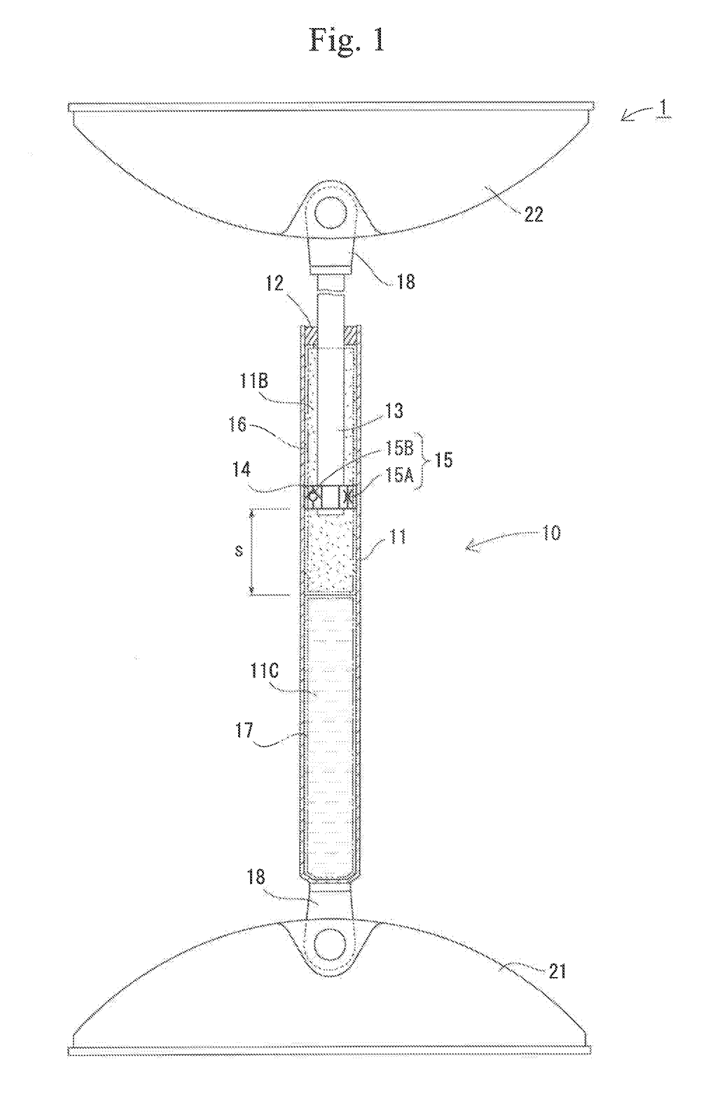

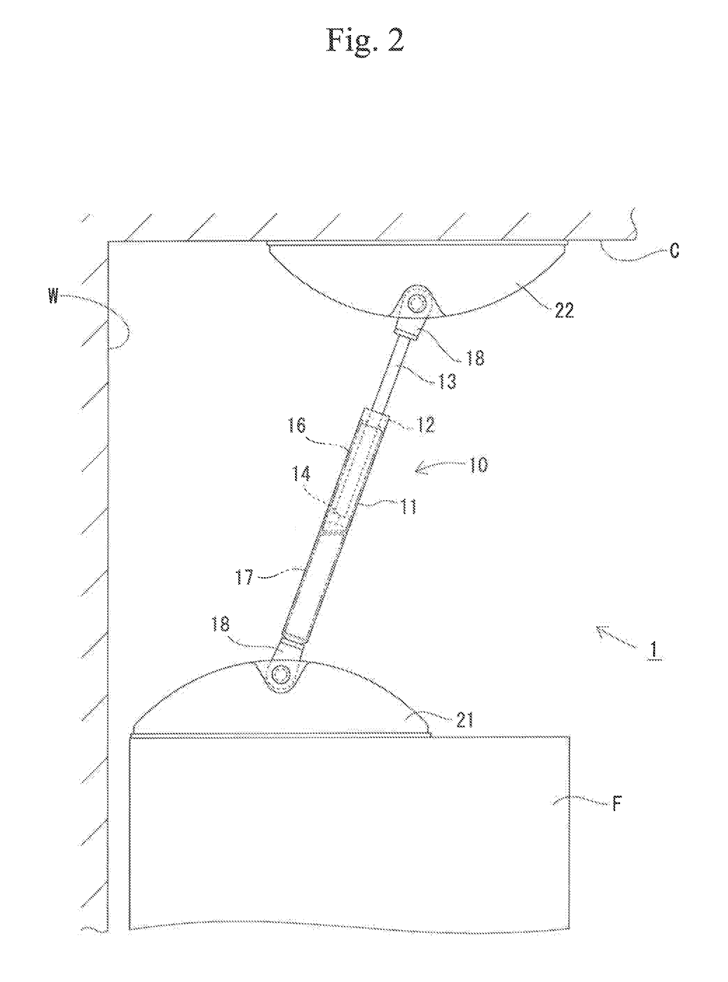

An overturn preventing device 1 of the embodiment includes a damper 10 as illustrated in FIGS. 1 and 2. The damper 10 is mounted between a top surface of a piece of furniture F (exemplified as an article in the invention) and a ceiling C. The damper 10 has two ends to which paired bases 21 and 22 are respectively coupled. The base 21 abuts against, the top surface of the furniture F and the base 22 abuts against the ceiling C.

One or more overturn preventing devices 1 are mounted between the top surface of the furniture F and the ceiling C as illustrated in FIG. 2. The overturn preventing device 1 prevents the furniture F from overturn by use of a damping force of the damper 10 when shaking of earthquake or the like tilts the furniture F. The furniture F is installed on a floor surface (not illustrated) while a rear surface of the furniture F is opposed to a wall surface W extending in a vertical direction from the floor surface. The furniture F is formed into a rectangular parallelepiped shape and has a door, a drawer (neither illustrated) and the like in a front (a right side as viewed in FIG. 2), so that clothes, accessories and the like can be housed in the furniture F. The furniture F has a rectangle-shaped horizontal section long in a right-left direction (a depthwise direction in FIG. 2) . When the overturn preventing device 1 is not mounted on the furniture F, the furniture F would possibly be tilted frontward (rightward in FIG. 2) by shaking of earthquake or the like thereby to be overturned.

The damper 10 includes a cylinder 11 and a piston 14. The damper 10 further includes a rod guide 12, a rod 13 and a damping part 15. The cylinder 11 is bottomed and has a cylindrical shape. The cylinder 11 encloses a hydraulic fluid (exemplified as an operating liquid) and a compressed gas. The rod guide 12 closes an opening of the cylinder 11. The rod 13 is inserted through the rod guide 12, so that a distal end thereof protrudes out of the cylinder 11. The piston 14 is slidably housed in the cylinder 11. The piston 14 is provided so as to divide an interior of the cylinder 11 into a rod side pressure chamber 11B housing a proximal end of the rod 13 and a counter-rod side pressure chamber 11C. The proximal end of the rod 13 is connected to the piston 14.

The damping part 15 applies resistance to a flow of the fluid moving between the rod side pressure chamber 11B and the counter-rod side pressure chamber 11C. The damping part 15 has an orifice 15A and a check valve 15B. The orifice 15A and the check valve 15B are respectively provided in flow paths communicating between the rod side pressure chamber 11B and the counter-rod side pressure chamber 11C. The orifice 15A applies resistance to the flow of fluid in both directions. The check valve 15B allows the fluid to flow from the rod side pressure chamber 11B to the counter-rod side pressure chamber 11C and blocks the reverse flow of the fluid. The orifice 15A and the check valve 15B are provided in the piston 14.

The damper 10 is a compression damper in which a damping force generated during an extending operation is smaller than a damping force generated during a contracting operation. The extending operation of the damper 10 refers to an operation which increases an amount of protrusion of the rod 13 out of the cylinder 11 and the length of the damper 10. The contracting operation of the damper 10 refers to an operation which reduces an amount of protrusion of the rod 13 out of the cylinder 11 and the length of the damper 10. An expansion force of the compressed gas enclosed in the cylinder 11 works in an extension direction of the damper 10.

The following will describe a mechanism of generating a damping force by the damper 10. The orifice 15A applies resistance to a flow of the hydraulic fluid between the rod side pressure chamber 11B and the counter-rod side pressure chamber 11C with both extending and contracting operations of the damper 10. The check valve 15B allows the hydraulic fluid to flow from the rod side pressure chamber 11B to the counter-rod side pressure chamber 11C but blocks the reverse flow of the hydraulic fluid. Accordingly, the damper 10 has two flow paths of the hydraulic fluid from the rod side pressure chamber 11B to the counter-rod side pressure chamber 11C during the extending operation, that is, one flow path including the orifice 15A and the other flow path including the check valve 15B. On the other hand, the damper 10 has only one flow path of the hydraulic fluid from the counter-rod side pressure chamber 11C to the rod side pressure chamber 11B through the orifice 15A during the contracting operation. Accordingly, the damping force generated by the damper 10 during the extending operation is smaller than the damping force generated by the damper 10 during the contracting operation.

The pair of bases are the first base 21 coupled to a bottom of the cylinder 11 and the second base 22 coupled to a distal end of the rod 13. The first base 21 abuts against the top surface of the furniture F. The second base 22 abuts against the ceiling C. The first and second bases 21 and 22 are provided so as to be rotatable relative to the damper 10. The first and second bases 21 and 22 have substantially the same form and structure.

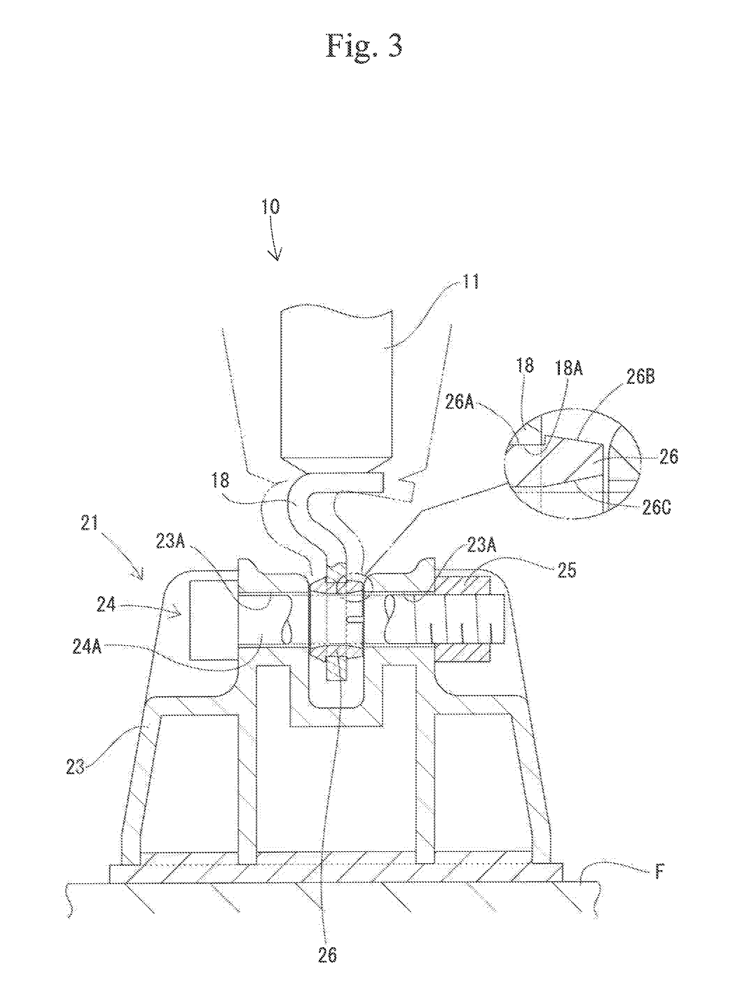

Furthermore, the damper 10 has two joints 18 provided on both ends thereof. Each joint 18 is formed by folding a flat plate-shaped metal fitting as illustrated in FIG. 3. The joints 18 are respectively connected to the bottom of the cylinder 10 and the distal end of the rod 13. Each joint 18 is formed with a through hole 18A extending therethrough in a direction perpendicular to an axis line of the damper 10.

The first and second bases 21 and 22 each have a base body 23, a bolt 24 and a nut 25 both serving as a rotating shaft member, and a bush 26. Since the first and second bases 21 and 22 have substantially the same form and structure, as described above, only the first base 21 will be described in the following.

The base body 23 is hollow as illustrated in FIG. 3. The base body 23 has insertion holes 23A through which the rotating shaft member is inserted. The rotating shaft member comprises the bolt 24 inserted into the insertion hole 23A from one of two sides of the insertion hole 23A and the nut 25 screwed onto a shaft 24A of the bolt 24. The bolt 24 has a central axis which serves as a rotation axis of the damper 10 in each of the bases 21 and 22.

The bush 26 is substantially cylindrical in shape as illustrated in FIG. 3. The bush 26 is elastic and has such a length that slight gaps are respectively defined between both end surfaces of the bush 26 and the base body 23 when mounted on the base body 23. The bush 26 has a recess 26A formed around an outer peripheral surface of a central part thereof. The recess 26A has an outer diameter that substantially equals an inner diameter of a through hole 18A formed in the joint 18 of the damper 10. The bush 26 has parts rising from both ends of the recess 26A and having outer diameters larger than the inner diameter of the through hole 18A formed in the joint 18 of the damper 10. Furthermore, both ends of the bush 26 have outer peripheral surfaces 26B the diameters of which are outwardly reduced. As a result, the bush 26 is inserted into the through hole 18A while being elastically deformed. The bush 26 is then attached to the joint 18 with the recess 26A being fitted in the through hole 18A.

The central part of the bush 26 has an inner diameter slightly larger than an outer diameter of the shaft 24A of the bolt 24. Both ends of the bush 26 have respective inner peripheral surfaces 26C the diameters of which are expanded outward. As a result, the bush 26 is rotatable about the shaft 24A of the bolt 24. Furthermore, the bush 26 is inclinable with respect to the shaft 24A of the bolt 24 to the extent that the inner peripheral surfaces 26C of both diameter-expanded ends thereof abut against the outer peripheral surface of the shaft 24A of the bolt 24. In other words, the damper 10 with the bush 26 attached to the joint 18 is rotatable about the shaft 24A of the bolt 24 and swingable in a direction intersecting with the rotation direction. Furthermore, the damper 10 can be swung in the direction intersecting with the rotation direction more largely by elastic deformation of the bush 26.

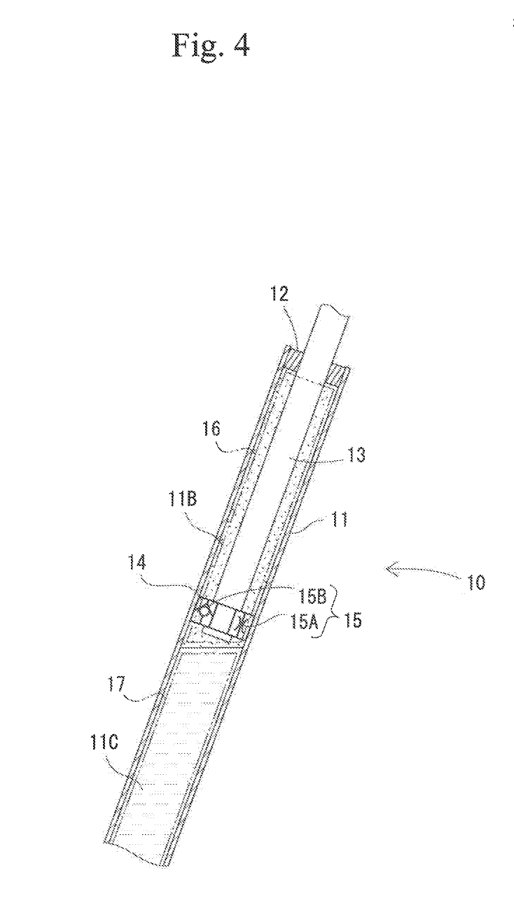

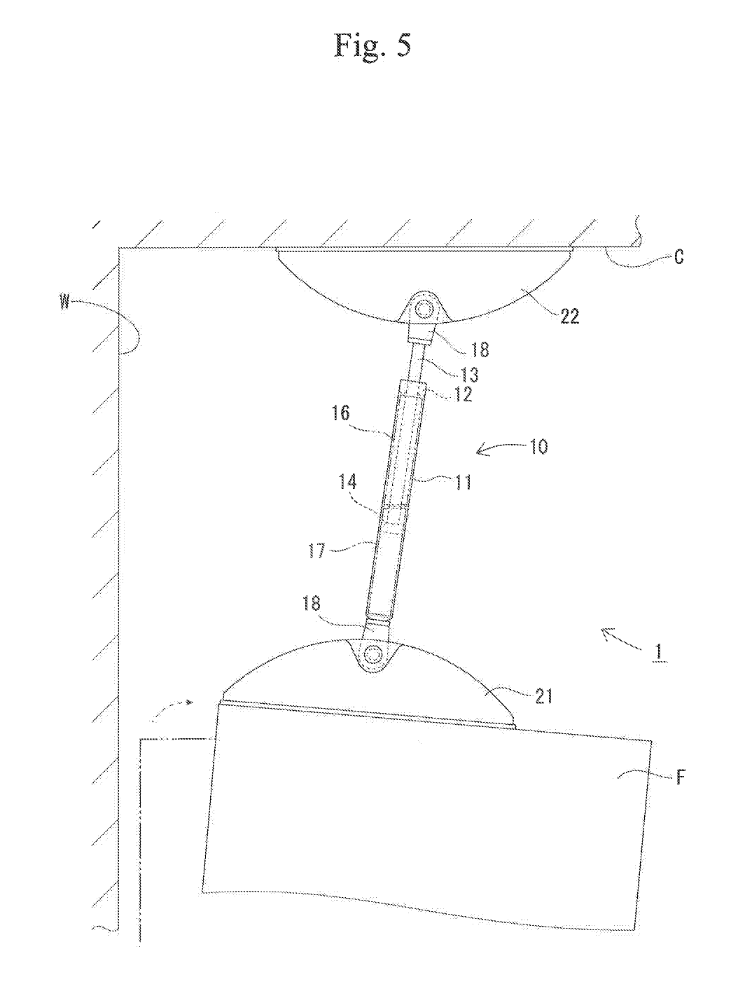

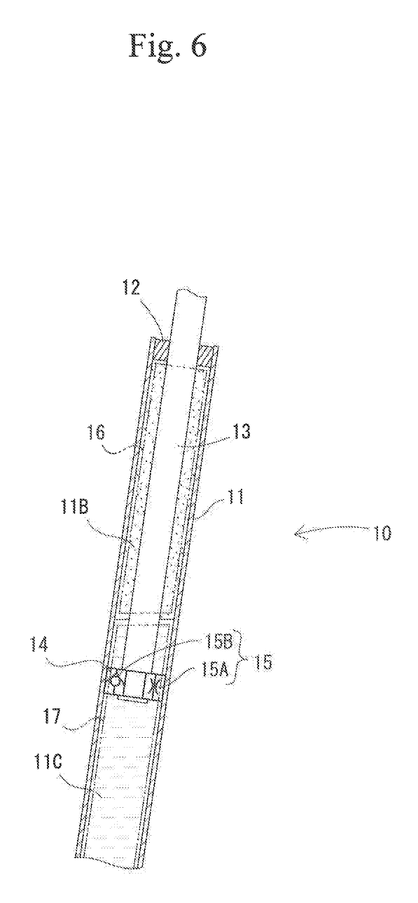

When the damper 10 is to be mounted between the top surface of the furniture F and the ceiling C, the piston 14 is housed in the compressed gas enclosed above the hydraulic fluid in the cylinder 11. More specifically, when the overturn preventing device 1 is to be mounted, the piston 14 is located in a compressed gas region 16 in the cylinder 11, as illustrated in FIGS. 2 and 4. Furthermore, when the furniture F is tilted with the result that the damper 10 is contracted by a predetermined length s, the piston 14 is moved into the hydraulic fluid. More specifically, when the furniture F is tilted by shaking of earthquake or the like with the result that the damper 10 is contracted by the predetermined length s, the piston 14 is moved from the compressed gas region 16 to a hydraulic fluid region 17 in the cylinder 11 as illustrated in FIGS. 5 and 6.

The overturn preventing device 1 thus constructed will be mounted between the top surface of the furniture F and the ceiling C in the following manner.

First, the damper 10 is contracted. In the contracted state of the damper 10, the piston 14 is housed in the compressed gas enclosed above the hydraulic fluid in the cylinder 11. The damper 10 is mounted between the top surface of the furniture F and the ceiling C in this state. More specifically, the first base 21 coupled to the lower end of the damper 10 is placed in abutment against on top surface of the furniture F. The damper 10 is mounted so as to have an inclination angle between 15° and 20° with respect to a vertical direction. The damper 10 is then extended with the inclination angle being maintained so that the second base 22 is caused to abut against the ceiling C. The locations of the bases 21 and 22 are adjusted so that the rotation direction of the damper 10 is substantially parallel to a direction in which the furniture F is tilted. During the mounting, the piston 14 is not moved into the hydraulic fluid region 17 and is slid only within the compressed gas region 16. As a result, the damper 10 can be contracted by a smaller load than in the case where the piston 14 is housed in the hydraulic fluid.

After the mounting, the rod 13 is protruded by an expansion force of the compressed gas so that the damper 10 is extended, with the result that a stretching force acts between the top surface of the furniture F and the ceiling C. As a result, the adjusted angle of the damper 10 and the locations of the bases 21 and 22 are suitably maintained. Furthermore, since the contracting operation of the damper 10 is carried out by the sliding of the piston 14 within the compressed gas region 16 as described above, the sliding of the piston 14 is also carried out within the compressed gas region 16 in the extending operation of the damper 10. Accordingly, the piston 14 is located in the compressed gas region 16 in the overturn preventing device 1 after the mounting.

The overturn preventing device 1 will work as follows. The overturn preventing device 1 is mounted such that the piston 14 is moved from the compressed gas region 16 to the hydraulic fluid region 17 when the damper 10 is contracted by the predetermined length s. When the damper 10 is contracted by not less than the predetermined length s by shaking of the furniture F due to earthquake or the like, the piston 14 in the cylinder 11 is moved from the compressed gas region 16 to the hydraulic fluid region 17. As a result, a damping force by the hydraulic fluid is generated in the damper 10. This can effectively damp the shaking of the furniture F. On the other hand, when the shaking of the furniture F is relatively smaller so that a contraction amount of the damper 10 is not more than the predetermined length s, the piston 14 in the cylinder 11 is slid only within the compressed gas region 16.

As described above, the overturn preventing device 1 of the foregoing embodiment includes the damper 10. The damper 10 is mounted between the top surface of the furniture F installed on the installation surface and the ceiling C. The damper 10 includes the cylinder 11 and the piston 14. The hydraulic fluid and the compressed gas are enclosed in the cylinder 10. The piston 14 is housed in the cylinder 11 so as to be slidable therein. When the damper 10 is to be mounted between the top surface of the furniture F and the ceiling C, the piston 14 is housed in the compressed gas enclosed above the hydraulic fluid in the cylinder 11.

In this overturn preventing device 1, the piston 14 is housed so as to be slidable in the cylinder 11 enclosing the hydraulic fluid and the compressed gas. The hydraulic fluid is enclosed below the compressed gas in the cylinder 11. When the damper 10 is to be mounted between the top surface of the furniture F and the ceiling C, the piston 14 is housed in the compressed gas. According to this configuration, the piston 14 is not located in the hydraulic fluid in the cylinder 11 when mounting the damper 10. Accordingly, the damper 10 can be contracted without drag caused by the hydraulic fluid. As a result, the damper 10 can be contracted with a smaller force than in the case where the piston 14 is housed in the hydraulic fluid.

Accordingly, the overturn preventing device 1 of the embodiment can easily be mounted between the top surface of the furniture F and the ceiling C.

Furthermore, the piston 14 is moved into the hydraulic fluid when the furniture F is tilted with the result that the damper 10 is contracted by the predetermined length s. In other words, the piston 14 is housed in the compressed gas until the damper 10 is contracted by the predetermined length s. When the article is tilted and the damper 10 is contracted by the predetermined length s, the piston 14 is caused to be housed in the hydraulic fluid. This generates a damping force by the hydraulic fluid. As a result, the tilt of the furniture F is suitably suppressed and thereby the furniture can be prevented from overturn.

The method of mounting the overturn preventing device 1 includes a step of mounting the damper 10 between the top surface of the furniture F and the ceiling C. When mounting the damper 10, the damper 10 is in a contracted state and the piston 14 is housed in the compressed gas in the cylinder 11. More specifically, the damper 10 is mounted while the piston 14 is not located in the hydraulic fluid. When the damper 10 in this state is set to the contracted state, drag by the hydraulic fluid is not generated. As a result, the damper 10 can be contracted with a smaller force than in the case where the piston 14 is housed in the hydraulic fluid.

Accordingly, the overturn preventing device 1 can easily be mounted between the top surface of the furniture F and the ceiling C by the mounting method of the embodiment.

The present invention should not be limited to the embodiment described above with reference to the drawings, but the technical scope of the invention encompasses the following embodiments, for example. (1) Although the overturn preventing device is mounted on the furniture in the foregoing embodiment, the overturn preventing device may be mounted on another article, for example, a bed having a plurality of beds connected to each other in the up-down direction, a large sized television, a refrigerator, a book shelve, a showcase or a server rack, all of which has a possibility of being overturned by shaking of an earthquake or the like. (2) Although the overturn preventing device is mounted on the furniture installed on the floor with the rear surface being opposed to the wall surface in the foregoing embodiment, the overturn preventing device may be mounted on a piece of furniture or the like installed on the floor without being adjacent to the wall surface. (3) Although the compression damper is used in the foregoing embodiment, the damper may be a two-way damper or an extension damper. When using these dampers, attention should be paid to the mounting locations and the numbers of the bases to be fixed to an article and the ceiling, and to the inclination angle and the inclination direction of the damper to be mounted. Thus, the damper needs to be mounted appropriately according to a type of the damper. (4) Although the damper is extended by the expansion force of the compressed gas in the embodiment, other means such as a compression coil spring or a combination of the other means may be used so that a biasing force is further applied to extend the damper. (5) Although the hydraulic fluid is used as the operating liquid to be enclosed in the cylinder in the embodiment, another liquid may be used as long as it generates a predetermined damping force.

### Explanation of Reference Symbols

C . . . ceiling; F . . . furniture (article); W . . . wall surface; 1 . . . overturn preventing device; 10 . . . damper; 11 . . . cylinder; 11B . . . rod side pressure chamber; 11C . . . counter-rod side pressure chamber; 12 . . . rod guide; 13 . . . rod; 14 . . . piston; 15 . . . damping part (15A . . . orifice, 15B . . . check valve); 16 . . . compressed gas region; 17 . . . hydraulic fluid (operating liquid) region; 18 . . . joint; 18A . . . through hole; 21, 22 . . . base (21 . . . first base, 22 . . . second base); 23 . . . base body; 23A . . . through hole; 24 . . . bolt; 24A . . . shaft; 25 . . . nut; 26 . . . bush; 26A . . . recess; 26B . . . outer peripheral surface; 26C . . . inner peripheral surface.

1. An overturn preventing device comprising:
a damper to be mounted between a top surface of an article installed on an installation surface and a ceiling, the damper including a cylinder enclosing an operating liquid and a compressed gas and a piston housed in the cylinder to be slidable,
wherein the piston is housed in the compressed gas enclosed above the operating liquid in the cylinder when the damper is to be mounted between the top surface of the article and the ceiling.

2. The overturn preventing device according to claim 1, wherein the piston is moved into the operating liquid when the article is tilted with a result that the damper is contracted by a predetermined length.

3. A method of mounting the overturn preventing device as defined in claim 1, comprising a step of mounting the damper between the top surface of the article and the ceiling while the damper is in a contracted state and the piston is housed in the compressed gas enclosed above the operating liquid in the cylinder.

4. A method of mounting the overturn preventing device as defined in claim 2, comprising a step of mounting the damper between the top surface of the article and the ceiling while the damper is in a contracted state and the piston is housed in the compressed gas enclosed above the operating liquid in the cylinder.
